(19) United States
(12) Patent Application Publication
(10) Pub. No.: US 2006/0239190 A1
(43) Pub. Date: Oct. 26, 2006

(54) Policy-based device/service discovery and dissemination of device profile and capability information for P2P networking

(75) Inventors: Brijesh Kumar, Princeton Junction, NJ (US); Mahfuzur Rahman, South Brunswick, NJ (US)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/113,955

(22) Filed: Apr. 25, 2005

(51) Int. Cl. H04L 12/26

(52) U.S. Cl. 370/230

(57) ABSTRACT

A discovery framework model includes policy information in the device/service discovery protocols. Service discovery protocols are enhanced by embedding policy information in the over all discovery framework. A method of performing policy-controlled device/service discovery includes modeling a device/service discovery protocol with a state machine either at a gateway or at discovery agents. Policies are used to control and propagate device/service discovery information. These policies are sets of rules that define conditions and attributes under which a certain action is permitted or denied.

### FIELD OF THE INVENTION

The present invention generally relates to device/service discovery protocols, and relates in particular to enhancement of these protocols by embedding policy information in an over all discovery framework.

### BACKGROUND OF THE INVENTION

The last several years have witnessed the proliferation of network-attached devices. As a consequence of this proliferation, an enormous expansion of services provided by different service providers has occurred. In addition to supporting traditional services such as voice, fax, printing, etc., service providers are expanding the horizon by enabling services like video on demand, music on demand etc. As this trend continues, it is essential to provide means to find and make use of services available in a network. Consider a scenario where a user is in a conference room with an Internet capable hand held device and it is connected to a wireless network provided by the conference. Assume that the user wishes to print a document; unless the user knows that there is a printer in the conference room and the name and address of the printer, it difficult to perform this action. However, if the user has a technology that automatically detects the devices available in the network and the services provided by them, it is easy for the user to find a printer and print the document. Thus, the idea of automatic service and device/service discovery is compelling in its potential applications.

There are number technologies that have emerged over the past few years for automatic device/service discovery by different industries and standard forums. The discovery of services and devices in an automated fashion is an essential part of current and future network infrastructure. Among the competing technologies, Service Location Protocol (SLP), Universal Plug and Play (UPnP), Jini, Salutations, and Service Discovery Protocol (SDP) of Bluetooth are showing significant promises. Device/service discovery is not only an important part of plug-and-play or support for SOHO (small office/home offices); it also has an ever-increasing impact on mobile and pervasive computing environments. A number of new applications use a Peer to Peer (P2P) communication paradigm. In such an environment, the importance of policy control of discovery information increases.

There are a number of well-known device/service discovery protocols. These protocols, while incompatible with one another, provide a number of core services to allow devices to discover each other and their services in data networks. The basic services provided by these protocols include discovery of devices/services, easy configuration, insertion, and deletion of services, service cataloging, eventing, etc. Some device/service discovery technologies, such as UPnP, are inherently peer-to-peer, allowing clients and services to directly address each other for the purposes of advertisement and discovery. Others, such as Jini, implement catalogs that track available services. Still others, such as SLP, can operate either with or without service catalogs. Some of them may allow scoping to limit the broadcast to a narrow geographical area to achieve scalability. However, this type of scoping is only device level scoping, not service level scoping.

The current generation of discovery protocols do not provide support for fine grained policies needed for a home networking environment where there is a greater need to control the access to individual services by the devices. Accordingly, there is a need for a way to control device access to individual services. The present invention fulfills this need.

### SUMMARY OF THE INVENTION

A method of performing policy-controlled device/service discovery includes modeling a device/service discovery protocol with a state machine either at a gateway or at discovery agents. Policies are used to control and propagate device/service discovery information. These policies are sets of rules that define conditions and attributes under which a certain action is permitted or denied.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram illustrating centralized policy-based device/service discovery;

FIG. 2 is a diagram illustrating registration of policy rules for a SIP-based device; and

FIG. 3 is a diagram illustrating controlled distribution using shared sub-groups.

### DETAILED DESCRIPTION OF THE PREFERRED EMBODIMENTS

The following description of the preferred embodiment(s) is merely exemplary in nature and is in no way intended to limit the invention, its application, or uses.

The present invention is a discovery framework model that includes policy information in the device/service discovery protocols. For example, consider a mobile-home scenario where the gateway is responsible to proxy device information within a home to the mobile device outside of home. The problem is that information about all discovered devices should not be sent to all mobile devices. There is a need to apply policy control on the device/service discovery information. This policy information can be part of the discovery protocol and can be sent along with the device/service discovery information or part of this information can be administered at the gateway. This innovation addresses these issues and provides solutions for inclusion of policy information in a device/service discovery protocol. In particular, the present invention enhances one or more device/service discovery protocols by embedding policy information in the over all discovery framework.

The present innovation presents many points of novelty. For example, in addition to introducing the idea of policy into device/service discovery protocols, the present invention provides a method for adding policy control to server based device/service discovery protocols using a centralized model for policy-based device/service discovery. It also provides a method for adding policy control for distributed device/service discovery protocols in a Peer to Peer (P2P) environment, and introduces the idea of policy-based device/service discovery and how it can be applied in Service Location Protocol (SLP), in a SIP-based approach used in a P2P environment, and in UPnP and JXTA network architecture. It further introduces configuring policy based on SIP URIs at the home gateway and other CE devices, and customizing device profiles based on policies applicable to the SIP URIs of the receiving device/user.

As mentioned above, the present innovation includes the addition of policy control to device/service discovery protocols. The idea of a policy-controlled device/service discovery is to first model the device/service discovery protocol with a state machine either at the gateway or at the discovery agents, and then use policy to control and propagate device/service discovery information. Policies in this context are sets of rules that define conditions and attributes under which a certain action is permitted or denied.

There are two approaches of policy control to device/service discovery in a mobile to home communication scenario. One of these approaches is termed herein control on distribution of discovery information. The other of these approaches is termed herein control on device service profiles by embedding policy information.

Control on distribution of discovery information is a method that is based on defining a policy framework which controls the distribution of device service capabilities in accordance with some locally defined policies that control which devices becomes visible outside to a mobile device. In this approach, policies need to be applied at a central exit place where a network server or gateway can apply policy decisions by using policies distributed or registered by various devices or using some other means.

Control on device service profiles by embedding policy information is a method that is based on letting devices distribute their capabilities to every one. However, these profiles carry policy information embedded along with capabilities that control how a receiver can use these services. In essence, the device capabilities are made available to a mobile device, and these policies control what device features or capabilities are made available to a mobile device.

The term “capability” is defined in RFC 2703 as an attribute of a sending or receiving device, which indicates an ability to generate or process a particular type of message content. The capabilities/preferences of a user agent include the hardware and software platform, system software, application, and user preferences, and it is intended to provide necessary information to adapt a mechanism for content delivery that best fit the user and its user agent. Device profile and capability can include but are not limited to the following information: (a) hardware characteristics; (b) software characteristics; (c) application/user preferences; and (d) network characteristics (bearer characteristics such as latency and reliability, etc.).

The above two approaches are described below in greater detail in the context of currently defined discovery protocols. Because, all existing device/service discovery protocols can be roughly grouped into centralized or distributed approaches, the method of policy control for each of these models is discussed.

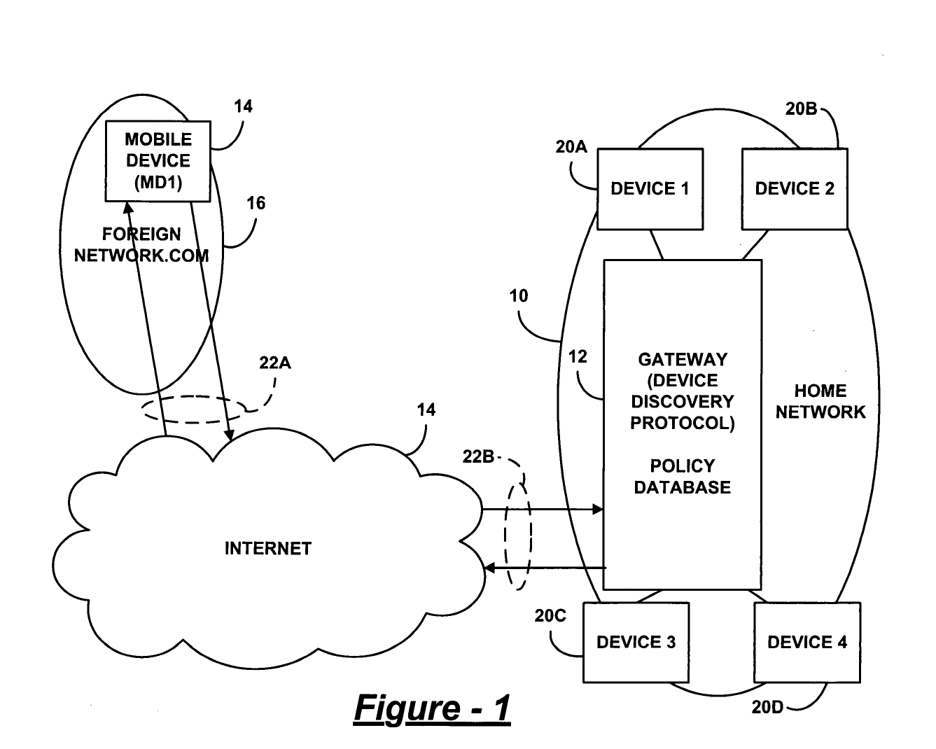

Referring to FIG. 1, a method for adding policy control to server based device/service discovery protocols employs a central egress point for a home network 10, such as a gateway 12 or server. The central egress point controls whether an external device 14 on a foreign network 16 connecting to the home network 10 via the Internet 18 or directly is able to access services of devices 20A-20D on the home network 10. The device/service discovery response 22A and 22B is filtered at the gateway 12 or server, which acts as a device/service discovery proxy employing a policy database as further explained below.

This server approach can be applicable to the following important device/service discovery protocols with some minor changes: SLP, UPnP, JXTA, etc. For Service Location Protocol (SLP), there is a directory agent running at the gateway that acts as a repository of device advertisements. The directory agent also has a proxy that filters device/service discovery information based on the applicable rules at the gateway. The way rules are administered is a local policy.

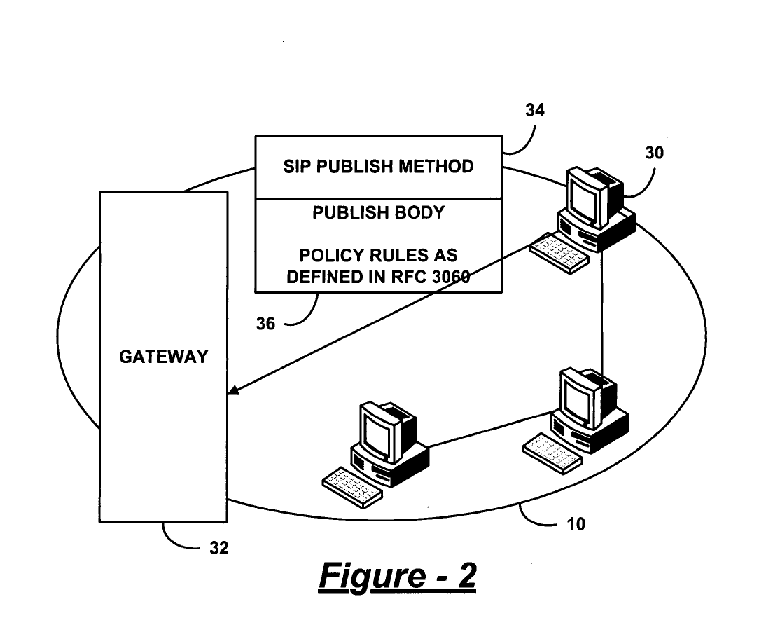

Turning now to FIG. 2, registration of policies can be accomplished in various ways. For example, a device 30 within a home network 10 can request its own policy rules and register it with the proxy 32 within the home network. The device can use HTTP or any other mechanism to register rules. If the device is SIP-based then it can use SIP PUBLISH, REGISTER methods or XCAP to register its own policy rules with the proxy. Use of the SIP publish method 34, for example, can involve employing a SIP PUBLISH BODY 36, wherein the description of rules can follow RFC 3060 (Policy Core Information Model). Also, in case of UPnP, a proxy 32 at the gateway can act as a repository of device/service discovery information and also can act as a proxy 32 to register and apply rules while propagating device/service discovery information. The publication of policy rules can be performed using HTTP or SOAP over HTTP etc. In case of JXTA, rendezvous peer at the gateway can also act as a repository of device/service discovery information.

Thus, dissemination of policy information can be accomplished. The decision to disseminate device profile information is made as follows: (1) each registering device at home gateway gets classified in the user class; (2) all requests to and from the device get filtered through the policy base; (3) any request incompatible with the policy base gets rejected.

The method for adding policy control for distributed device/service discovery protocols in a Peer to Peer (P2P) environment takes the approach of administering policy locally at the device. When making device/service advertisement announcements, the device will also send out the policy information in addition to information regarding the device itself. Thus, when a mobile device makes a request to discover a device within a home, the device responding to the request will apply policy based on the URI of the mobile device. If, according to the policy, the mobile device is authorized to receive device information, it will be sent to the mobile device.

In distributed device/service discovery protocols, there are two approaches to policy dissemination. One of these approaches is termed herein controlled distribution using shared sub-groups. The other of these approaches is termed herein open distribution using embedded policy information.

Controlled distribution using shared sub-groups can be used both to allow policy control as well as allow scalability. For example, not all of the devices within a home will have the privileges to see all the devices and their services. In such a situation, devices will be classified according to device/user class. When advertising device-discovering information for a particular class, the information will be encrypted with a key that is devoted to that particular class. Thus, only devices with the appropriate key will be able to see the advertisements and/or messages. The policy to assign devices to different classes is made by an administrative domain.

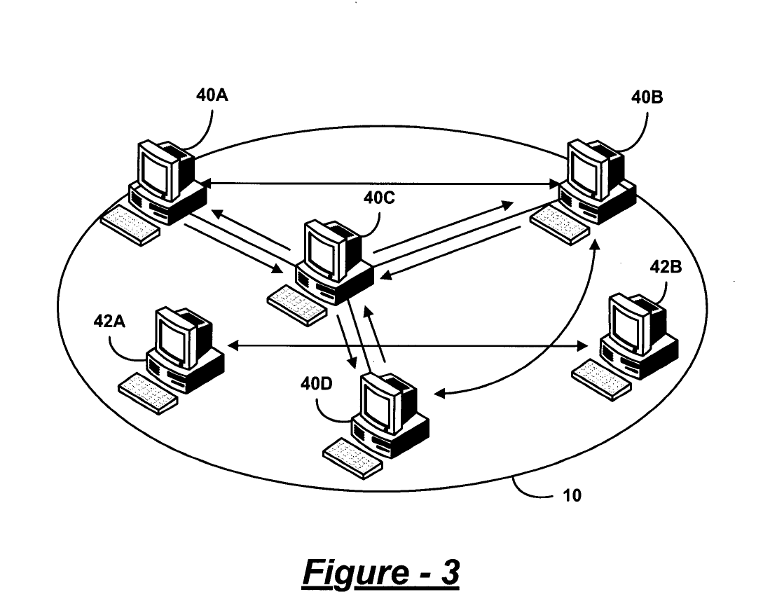

Turning now to FIG. 3, devices 40A-40D in home network 10 are in the same category and, hence, they are able to decipher device advertisements information from each other. However, as devices 42A and 42B in home network 10 fall in a different category, devices 40A-40D are not be able to decipher any advertisements sent out by devices 42A-42B.

Representation of policy information can be accomplished in various ways. For example, assume there is a media server device A that has a number of services offered to other devices. A basic discovery message from this device includes device information, service information and policy information. A device data description has attributes like: device name; model number; manufacturer; ip address; url or any other device specific information. The services define actual services offered by the devices. For example, a media server can allow search, record, copy, delete, move and format conversion operations on its stored media files. But, not every one may be allowed all these operations. The policies define rules under which services can be used and by which devices. Policy elements may include: receivers scope, expiration date, time of day, inclusion, exclusion scopes, services covered under that policy, etc.

In this case, a device may create a service discovery message similar to the one below:

<?xml version = “1.0”>

<scopegroup> List of Device Groups Allowed to Use This Data

</scopegroup>

// Description of Device Identification data //
<device> Description of Device - device data will be encrypted

</device>

// List of services offered by the devices - service data will be

encrypted //

<serviceList>

<service> Service 1 </service>
<service> Service 2 </service>
... ...
<service> Service n </service>

</serviceList>
// Policies that should be used to control the access to above

services //

<PolicyList>
<policy> Policy 1 </policy>
<policy> Policy 2 </policy>
..
<policy> Policy n </policy>

/<device>

Open distribution can be performed using embedded policy information. In this method, no attempt is made to restrict information to any particular set of devices, instead policies include the list of services allowed to other devices that meets the rules set for a particular service. For example, a guest to a home may use a Panasonic DVD player to stream a movie, provided the guest has no access to a low quality DVD player manufactured by a no name company. We assume that all devices in the home environment are trusted and there is no need to hide devices but only control the access to services under policies.

Taking the previous example of the media server, the discovery message in this case can be:

<?xml version = “1.0”>
// Description of Device Identification data //
<device> Description of Device </device>
// List of services offered by the devices //
<serviceList>

<service> Service 1 </service>
<service> Service 2 </service>
... ...
<service> Service n </service>
</serviceList>

// Policies that should be used to control the access to above

services //

<PolicyList>
<policy> Policy 1 </policy>
<policy> Policy 2 </policy>
..
<policy> Policy n </policy>
</policyList>

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of performing policy-controlled device/service discovery, comprising:
modeling a device/service discovery protocol with a state machine either at a gateway or at discovery agents;
using one or more policies to control and propagate device/service discovery information, wherein policies are sets of rules that define conditions and attributes under which a certain action is permitted or denied.

2. The method of claim 1, further comprising employing control on distribution of discovery information by defining a policy framework which controls distribution of device service capabilities in accordance with locally defined policies that control which devices within a home network become visible to devices outside the home network.

3. The method of claim 2, wherein policies are applied at a central egress point of the home network where a network server or gateway can apply policy decisions.

4. The method of claim 3, further comprising employing, for SLP, a directory agent running at the gateway that acts as a repository of device advertisements.

5. The method of claim 4, wherein the directory agent also has a proxy that filters device/service discovery information based on applicable rules at the gateway, and the way rules are administered is a local policy.

6. The method of claim 3, further comprising employing for UPnP a server at the gateway that acts as a repository of device/service discovery information and also acts as a proxy to register and apply rules while propagating device/service discovery information.

7. The method of claim 6, further comprising performing publication of policy rules using HTTP or SOAP over HTTP.

8. The method of claim 3, further comprising, for JXTA, employing rendezvous peer at the gateway to act as a repository of device/service discovery information.

9. The method of claim 3, wherein the network server or gateway applies policy decisions by using policies distributed or registered by various devices.

10. The method of claim 3, further comprising accomplishing registration of policies with the central egress point.

11. The method of claim 10, wherein a device within the home network requests its own set of policy rules and registers it with a proxy at the central egress point.

12. The method of claim 11, wherein the device uses HTTP to register rules.

13. The method of claim 11, wherein the device is SIP-based and uses SIP PUBLISH, REGISTER methods or XCAP to register its own policy rules with the proxy.

14. The method of claim 11, wherein the description of rules follows RFC 3060 (Policy Core Information Model).

15. The method of claim 2, wherein a decision to disseminate device profile information is made as follows:
(1) each registering device at a home gateway gets classified in a user class;
(2) all requests to and from the device get filtered through a policy base; and
(3) any request incompatible with the policy base gets rejected.

16. The method of claim 1, further comprising employing control on device service profiles by embedding policy information, wherein devices are allowed to distribute their capabilities to other devices as profiles, and the profiles carry, embedded along with the capabilities, policy information that controls how a receiver can use services of the devices, such that the device capabilities are made available to a receiver, and the policy information controls what device features or capabilities are made available to the receiver.

17. The method of claim 1, further comprising, in a Peer to Peer (P2P) environment, administering policy locally at a device.

18. The method of claim 17, wherein, when making device/service advertisement announcements, the device also sends out the policy information in addition to information regarding the device itself.

19. The method of claim 18, wherein when an external device outside a home network makes a request to discover the device within the home network, the device responding to the request applies policy based on the URL of the external device, such that if, according to the policy, the external device is authorized to receive device information, the external information is sent to the external device.

20. The method of claim 1, further comprising, in distributed service discovery protocols, employing controlled distribution using shared sub-groups to allow policy control and allow scalability.

21. The method of claim 20, wherein not all of the devices within a home network have privileges to see all devices and their services in the home network.

22. The method of claim 21, wherein devices are classified according to device/user class, and, when advertising device-discovering information for a particular class, the information is encrypted with a key that is devoted to that particular class, such that only devices with the appropriate key will be able to see the advertisements and/or messages.

23. The method of claim 22, wherein a policy to assign devices to different classes is made by an administrative domain.

24. The method of claim 1, further comprising, in distributed service discovery protocols, employing open distribution using embedded policy information.

25. The method of claim 24, wherein no attempt is made to restrict information to any particular set of devices, and policies include a list of services allowed to other devices that meet a rules set for a particular service.

26. The method of claim 1, further comprising representing policy information by employing a discovery message from a device that includes device information, service information and policy information, wherein the device information describes device-specific attributes, the services information defines actual services offered by the devices, and the policy information defines rules under which services can be used and by which devices.

27. The method of claim 26, wherein the device specific attributes include at least one of: device name; model number; manufacturer; ip address; or url.

28. The method of claim 26, wherein the policy information includes at least one of: receivers scope, expiration date, time of day, inclusion, exclusion scopes, or services covered under that policy.
